(19) United States
(12) Patent Application Publication
(10) Pub. No.: US 2018/0134067 A1
(43) Pub. Date: May 17, 2018

(54) PORTABLE WHITEBOARD WITH A FLEXIBLE FOAM LAYER

(71) Applicant: Whitey Board Company, Calabasas, CA (US)

(72) Inventor: Josh Jennings, Calabasas, CA (US)

(73) Assignee: Whitey Board Company, Calabasas, CA (US)

(21) Appl. No.: 15/353,684

(22) Filed: Nov. 16, 2016

(51) Int. Cl. B43L 1/00; B65D 3/04

(52) U.S. Cl. CPC B43L 1/00; B65D 3/04

(57) ABSTRACT

The present invention provides a stick on whiteboard that uses a premium high density flexible foam layer between an adhesive layer and a writing board layer. The adhesive layer attaches to a wall or other surface, and the writing board layer receives writing from a dry erase marker. The flexible foam layer is thick enough to block wall texture and write on easily, applies easier eliminating air bubbles in the adhesive layer, and is portable due to being flexible enough to allow the whiteboard to be rolled up by a user like a poster and the adhesive layer allows the whiteboard to be unrolled without damage or residue.

### BACKGROUND OF THE INVENTION

### 1. Field of Invention

The present invention relates to whiteboard apparatuses for receiving writing from a dry erase marker, and more specifically, to portable adhesive whiteboard apparatuses.

### 2. Description of Related Art

A whiteboard, also referred to as a dry-erase board, is surface for nonpermanent markings by a dry erase marker. Traditional whiteboards are glossy, white, and used in school classrooms and work meeting rooms. Unlike blackboards which use chalk, whiteboards use dry erase markers and have a glossy smooth writing surface. Traditional whiteboards are typically manufactured with a melamine, porcelain, or aluminum surface, where melamine is painted onto a hard dry erase surface that allows marker ink to penetrate and porcelain is manufactured with an enamel surface with varying degrees of ink resistance.

Nowadays there are more advanced adhesive whiteboards, which have the glossy smooth writing surface of the traditional whiteboard, but contain a fully adhesive backing to attach to a smooth flat surface. These adhesive whiteboards, also called stick-on whiteboards, tend to be lighter and smaller than traditional whiteboards. Adhesive whiteboards products are very thin, similar in thickness to a sticker decal or a window tinting. Some adhesive whiteboards use a paper middle layer that allow them to be rolled up. Adhesive whiteboards provide a more modern, sleek look unlike the bulky traditional whiteboards.

A problem with conventional adhesive whiteboards is that they are difficult to write on due to the texture of a wall or other surface that the whiteboard is attached to. The texture shows through the whiteboard, and the texture is neither a smooth writing surface nor aesthetically pleasing. Conventional adhesive whiteboards do a poor job of preventing wall texture from interfering with the writing, limiting usage to flush, completely flat and hard surfaces, such as being attached to a traditional whiteboard. The very thin layer of the whiteboard does not work on a textured surface like wood or a bumpy wall due to the texture of these surfaces.

Another problem with conventional adhesive whiteboards is that they are difficult to attach to a wall without air bubbles. It is common for the first attachment to have air bubbles, such that the adhesive whiteboard needs to be pulled back and reattached. At least some air bubbles are an unavoidable downside of using adhesive whiteboards.

A further problem with conventional adhesive whiteboards is that they are not practical to transport. Unless the user keeps the wax paper backing, the user cannot really roll and then unroll the adhesive board back up because the whiteboard gets stuck onto itself. When unrolling, even if the whiteboard is not damaged, it would still retain an undesirable sticky residue after unrolled.

Also, many adhesive whiteboards contain a very thin cardboard middle layer that may be described as being flexible as it can bend slightly, but they cannot be folded or rolled up without ruining the adhesive whiteboard. These cardboard adhesive whiteboards cannot be bent slightly without creating an unpleasant visual look. Although these whiteboards are light, they need to transported flat. This limits the size to that of the flat area of a typical carrying case, such as a backpack, briefcase, or purse, which makes larger adhesive whiteboards unrealistic to transport. Other whiteboard exist, called presentation boards, which might be described as having foam, but it is a very sturdy foam, which is not flexible at all. Conventional whiteboards lack a layer that is easy to write on, always without bubbles, and portable.

### SUMMARY OF THE INVENTION

The present invention provides a stick on whiteboard that uses a premium high density flexible foam layer between an adhesive layer and a writing board layer. The adhesive layer attaches to a wall or other surface, and the writing board layer receives writing from a dry erase marker. The flexible foam layer is thick enough to block wall texture and write on easily, applies easier eliminating air bubbles in the adhesive layer, and is portable due to being flexible enough to allow the whiteboard to be rolled up by a user like a poster and the adhesive layer allows the whiteboard to be unrolled without damage or residue.

In one embodiment, an apparatus comprises: an adhesive layer configured to be attached to a surface; a writing board layer configured to be written on by a marker; and a flexible foam layer attached to the adhesive layer and the writing board layer, wherein the flexible foam layer is between the adhesive layer and the writing board layer, wherein the flexible foam layer comprises a foam, wherein the foam comprises a thickness to block wall texture from reaching the writing, wherein the foam comprises a foam material that prevents bubbles, wherein all layers of the apparatus are rollable and unrollable without damaging the flexible foam layer through bending and without damaging the adhesive layer and the writing board layer by having the adhesive layer stuck onto the adhesive layer itself or the writing board layer.

In another embodiment, a method comprises the steps of: producing an adhesive layer configured to be attached to a surface; producing a writing board layer configured to be written on by a marker; and producing a flexible foam layer attached to the adhesive layer and the writing board layer, wherein the flexible foam layer is between the adhesive layer and the writing board layer, wherein the flexible foam layer comprises a foam, wherein the foam comprises a thickness to block wall texture from reaching the writing, wherein the foam comprises a foam material that prevents bubbles, wherein all layers of the apparatus are rollable and unrollable without damaging the flexible foam layer through bending and without damaging the adhesive layer and the writing board layer by having the adhesive layer stuck onto the adhesive layer itself or the writing board layer.

In a further embodiment, a method comprises the steps of: attaching an adhesive layer to a surface; writing on a writing board layer using a marker; and using a flexible foam layer attached to the adhesive layer and the writing board layer, wherein the flexible foam layer is between the adhesive layer and the writing board layer, wherein the flexible foam layer comprises a foam, wherein the foam comprises a thickness to block wall texture from reaching the writing, wherein all layers of the apparatus are rollable and unrollable without damaging the flexible foam layer through bending and without damaging the adhesive layer and the writing board layer by having the adhesive layer stuck onto the adhesive layer itself or the writing board layer.

An advantage of the invention is the whiteboard is easier to write on and can be used on any wall. The whiteboard is easier to write on because the texture of the writing surface, such as a wall surface or wood surface, does not show up when writing. The flexible foam layer protects the writing surface from the wall's texture and makes it easier to write on and provides a buffer such that the whiteboard can be used on any textured surface. As such, the flexible foam layer allows the whiteboard to be used on realistic wall surfaces, and is not limited to flush completely flat and hard surfaces, such on top of a traditional whiteboard.

Another advantage of the invention is the whiteboard is much easier to attach to the wall while avoiding air bubbles or creases. It has been discovered that a high density premium foam eliminates air bubbles and wrinkles and the user can just slap it on. The whiteboard sticks to the wall in seconds, never having bubbles or wrinkles due to the premium foam.

A further advantage of the present invention is that the whiteboard is portable. The whiteboard is portable due to being rollable and unrollable making the whiteboard practical to transport while remaining practical to write on less than ideal surfaces. By being unrollable, the whiteboard does not act like a sticker that sticks to itself when rolled up causing damage or residue markings when unrolled. By being rollable, the whiteboard does not need to be transported flat as it can be rolled up like a poster.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a front perspective view of a portable whiteboard with a flexible foam layer according to an embodiment of the invention;

FIGS. 2-3 illustrate front perspective views of the whiteboard with an optional removable release liner according to an embodiment of the invention;

FIG. 4 illustrates a side view of the multiple layers of the whiteboard according to an embodiment of the invention;

FIG. 5 illustrates a perspective view of a packaging tube for carrying the whiteboard according to an embodiment of the invention; and

FIG. 6 illustrates a process of using the whiteboard according to an embodiment of the invention.

### DETAILED DESCRIPTION OF EMBODIMENTS

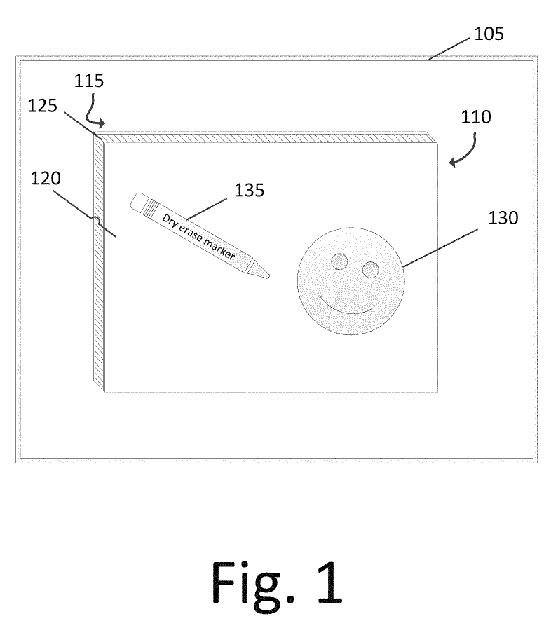

Further features and advantages of the invention, as well as the structure and operation of various embodiments of the invention, are described in detail below with reference to the accompanying FIGS. 1-6, wherein like reference numerals refer to like elements.

Although the present invention is described at times in the context of a whiteboard for a wall, one with skill in the art realizes that the adhesive on the whiteboard can be attached wide array of other surfaces and still be practical to write on due to the support provided by the high density flexible foam layer.

Embodiments of the invention provide a premium foam portable stick-on whiteboard. The conventional products are stick on vinyl, very thin, like the fathead decal products that stick to a user's wall. These conventional products look like a giant sticker, made out of vinyl, because vinyl erases nice and clean.

There are considerable advantages to this category of adhesive whiteboards, as well as inherent disadvantages when compared to the category of traditional non-adhesive whiteboards. The reduced material size and weight of the adhesive whiteboards create pricing advantages, reduce transit and manufacturing costs, and facilitate the installation process. The drawbacks are that the adhesive products can only be applied to smooth flat surfaces, and even then, certain complications such as the formulation of air pockets and wrinkles in the material can be unavoidable at times.

The premium foam whiteboard is an innovative solution that has eliminated all of the disadvantages intrinsic to adhesive whiteboards, without compromising the distinguishing factors that make it desirable compared to a traditional whiteboard. The inventive flexible foam layer has made installation virtually fail proof, completely eliminating an outcome where air bubbles and wrinkles lead to product failure, which has been discovered through extensive research and development as well as tireless trial and error.

Moreover, this new product can be applied to a wide array of surfaces and is not confined to the old parameters of only smooth flat surfaces being suitable for installation. The increase in thickness over comparable products translates into a writing surface that is always smooth and impervious to surface texture showing through to the whiteboard side, referred to herein as the writing board layer, which is the writing surface. For example, when a wall has too much texture for a conventional adhesive whiteboard, the foam backing on this whiteboard can be applied to directly to the wall or onto the conventional adhesive whiteboard to resolve this issue.

FIG. 1 illustrates a front perspective view of a portable whiteboard 110 with a flexible foam layer 125 according to an embodiment of the invention. On a wall 105 or other surface, the whiteboard 110 includes multiple layers 115, this figure's reference numbers showing a writing board layer 120 above the flexible foam layer 125. The writing board layer 120 receives writing 130 from a marker 135. The whiteboard 110 is thick and firm enough to block wall texture from affecting the writing 130 and to prevent air bubbles during attachment making attaching easier. The whiteboard 110 is also flexible enough to be rollable and portable, yet the adhesive layer does not get stuck onto itself making unrolling not possible or messy.

The wall 105 provides a backing for the whiteboard 110 to attach to. Unlike conventional adhesive whiteboards, the whiteboard 110 is not limited to very hard and smooth surfaces like another traditional blackboard that commonly exist in classrooms and business meeting rooms. The wall 105 can be a wall of meeting room, as the flexible foam layer 125 of whiteboard 110 prevents the wall texture from affecting the writing 130 due to typical small bumps on the wall's surface. The wall 105 does not need to be smooth or flush. Further, the wall 105 does not need to be impenetrable to text indentations, as the flexible foam layer 125 of the whiteboard 110 prevents text indentations from developing on the wall 105 when used as a writing surface backing for a non-dry erase marker.

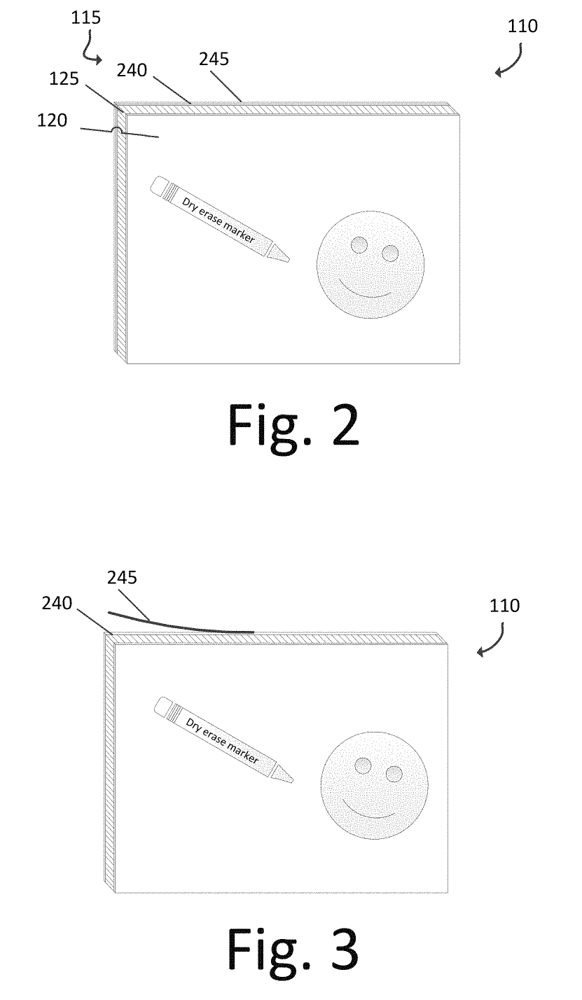

The whiteboard 110, also referred to as an apparatus, stick-on whiteboard, and portable whiteboard, includes an adhesive layer (discussed in FIGS. 2-3) that attaches to the wall 105 and the writing board layer 120 that is configured to be written on. Between the adhesive layer and the writing board layer 120 is a novel flexible foam layer 125. Conventional adhesive whiteboards do not have a foam layer.

The multiple layers 115, in one embodiment, include the writing board layer 120 on top, the flexible foam layer 125 in the middle, the adhesive layer on the bottom, with the possibility of an optional removable release liner (discussed in FIGS. 2-3) below that, covering the adhesive layer.

The writing board layer 120, which may also be referred to as a vinyl layer, writeable surface, etc., is a glossy white vinyl surface, such as Polyvinyl chloride (PVC), and the writing board layer 120 is configured to be written on by the dry erase marker 135. The vinyl layer 120 is stuck to the foam 125. Like the remaining layers, the writing board layer 120 is flexible such that it can roll into a tube shape. In one embodiment, the writing board layer 120 is 0.18 millimeters (mm), although other thicknesses are within the scope of this invention. This vinyl surface 120 is adhered to a dense foam 125.

The flexible foam layer 125 includes a premium foam to prevent the texture from the wall 105 from showing in the writing 130 on the whiteboard 110 and is also rollable. The flexible foam layer can also be referred to as a foam integration cushion technology, foam backing, high density foam, adaptive foam backing, a dense foam, a thick foam, etc.

Through research, the variance in thickness of flexible foam layer was finely tuned; at a certain point the product would become too heavy and fall off, or conversely if it was too thin it would succumb to the same shortcomings of the other adhesive whiteboards on the market. In one embodiment, the foam thickness of the flexible foam layer is in a range of 1 mm. In one embodiment, the foam layer 125 is a Polyethylene (PE) type foam as PE is most compatible with our adhesive and writing surface.

In one embodiment, a high density foam typically includes properties that are rigid and do not conform to curved or rounded surfaces. High density foam products currently available in the marketplace tend to be limited to smooth and flat surfaces as the material is not flexible. For example, the most common are foam poster boards that are widely used/seen in classrooms and meetings for presentations and/or projects. Although these can be hung on the wall preventing texture and/or set on an easel, they cannot be rolled up and bent as this would permanently damage its appearance and functionality. The polyethylene foam material proposed herein is both flexible and self-adhesive. In fact, the foam can be rolled up and reused, it can be bent and it can be applied over lightly texture surfaces without a need to use pins, double sided tape, easels or any other additional tool to position it. These can be repositioned time and time again and can be stored in its packaging tube.

The portable whiteboard 110, also referred to as a portable and reusable drive erase foam whiteboard, arose after significant research. The idea arose to make the writing board layer 120 use a dry erase surface on the front, rather than a transparent film or laminate like insert on the front, and the flexible foam layer 125 be incorporated as thicker flexible backing similar to that of a mouse pad, and through trial and error, use the adhesive layer 240 as the backing to best suit the needs of the market.

The flexible foam layer 125 gives the user a perfectly smooth writing surface that will not conform to wall texture, similar to the concept of a mouse pad on the user's desk. This adaptive foam backing creates a smooth surface for the user every time.

The thickness of the foam 125 prevents air bubbles as well. For example, when applying a large 4 by 6 foot conventional adhesive whiteboard, it is likely that air will get trapped creating air bubbles or creases. Even for small sized adhesives, like decal stickers, they typically have air bubbles at least on the first attachment try, requiring the user to have to pull the decal back and try again because they are difficult to attach.

The writing 130 and marker 135 are known by one with ordinary skill in the art. The writing 130 shows text or a design drawn by a user and the marker 135 can be a dry erase marker used for conventional whiteboards. The writing 130 and marker 135 are illustrated to indicate that the front layer is the writing surface configured to be written on, whereas the back layer is the adhesive surface configured to attach to the wall 105.

FIGS. 2-3 illustrate front perspective views of the whiteboard 110 with an optional removable release liner 245 according to an embodiment of the invention. The whiteboard 110 includes the writing board layer 120, the flexible foam layer 125, an adhesive layer 240, and the optional removable release liner 245.

The adhesive layer 240 is configured to stick to the wall 105 or other surface. The adhesive layer 240 uniformly covers the entire foam 125 to ensure a smooth writing surface for the user. The adhesive layer 240 sticks to the wall 105 multiple times making the whiteboard 110 restickable. The whiteboard 110 achieves a combination of material density and depth that creates a clinging sensation that bolsters the strength of the adhesion to the surface and at same time revolutionized installation so that a user could now quite literally slap the product onto the wall in seconds without a single bubble or wrinkle.

The adhesive of the adhesive layer 240 can be safely removed without risking any damage to the surface 105 when removing. Further, the adhesive layer 240 does not get stuck to itself making it unrollable without the damage of getting stuck to itself or producing a sticky residue. In one embodiment, the adhesive layer is specially formulated to be compatible with Polyethylene (PE) plastics, which is found in both the foam layer and the writing surface of the board. After trial and error with other materials such as polyvinyl chloride (PVC), it was found that adhesive with those other materials were not as compatible. Over long periods of time the adhesive of PVC and other materials were breaking down, leaving residue on surfaces and losing strength pertaining to its adhesive properties. So in conclusion, in this embodiment it was found that using PE type plastics for the foam layer as well as the writing surface were more chemically stable with our adhesive. This discovery allowed the product to roll up onto its self without leaving any residue and also unroll from the surface without getting stuck to its self.

This research led to the creation of the first and only truly portable adhesive whiteboard. The adhesive is so adaptable that not only can it be removed countless times without losing its adhesive properties, but it can be rolled onto itself, and re-packaged allowing it to become mobile.

The true portability of the whiteboard 110 makes mobility a reality. For a user to take the whiteboard with them, they simply remove it, roll it up, and reapply it anywhere creative thinking is needed. The whiteboard can record the user's ideas as the user continues to think and move through the day, such that versatility meets affordability.

Typically, with adhesive whiteboards, even if you are able to remove them without causing damage to the surface, the adhesive will have been weakened to the extent that it will not re-stick in a new location. The other concern is that the adhesive will stick to either itself or the whiteboard side which causes product failure. Not to mention the aggravation caused by trying to maneuver something so large, thin, awkward, and very sticky.

The optional removable release liner 245 covers the adhesive layer 240 to prevent the adhesive layer from sticking. In one embodiment, the release liner 245 is a one-use disposable plastic film, removed when the whiteboard is ready to attach to the wall 105 and the release liner 245 is disposed of after removable. In this embodiment, the release liner 245 can be a one-time use wax coated backing paper. In another embodiment, the release liner 245 is a reusable cover for the adhesive layer 240 between uses.

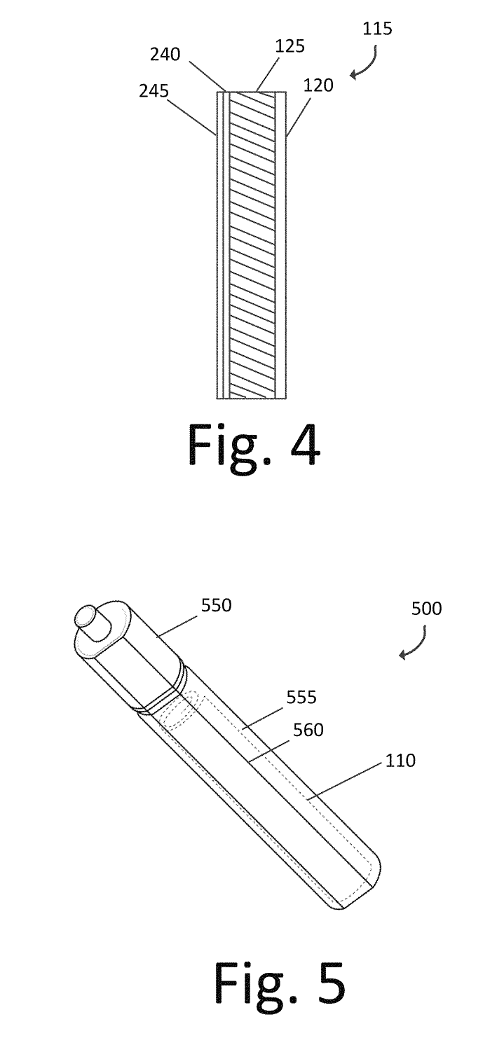

FIG. 4 illustrates a side view of the multiple layers 115 of the whiteboard 110 according to an embodiment of the invention. The multiple layers 115 include the writing board layer 120, the flexible foam layer 125, the adhesive layer 240, and the removable release liner 245. The flexible foam layer 125 lies between the writing board layer 120 and the adhesive layer 240.

FIG. 5 illustrates a perspective view of a packaging tube 500 for carrying the whiteboard 110 according to an embodiment of the invention. The package tube 500 comprises a cap 550 and a body 555 having a flat edge 560. By being rollable and portable, the whiteboard 110 can be transported in the packaging tube 500.

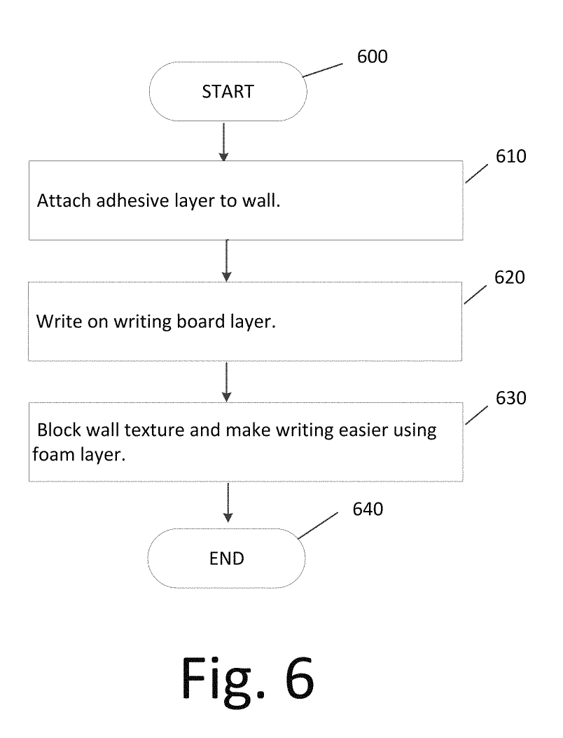

FIG. 6 illustrates a process of using the whiteboard 110 according to an embodiment of the invention. The process starts at step 600. At step 610, a user removes the release liner 245 and attaches the adhesive layer 240 of the whiteboard 110 to the wall 105. The whiteboard 110 can attach to and work with a broad range of surfaces. At step 620, the user writes on the writing board layer 120 of the whiteboard 110. At step 630, the flexible foam layer 125 provides a firm support blocking wall texture and making writing on a non-smooth surface practical. The process may be repeated recursively a number of times and ends at step 640.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. An apparatus comprising:
an adhesive layer configured to be attached to a surface;
a writing board layer configured to be written on by a marker; and
a flexible foam layer attached to the adhesive layer and the writing board layer, wherein the flexible foam layer is between the adhesive layer and the writing board layer,
wherein the flexible foam layer comprises a foam, wherein the foam comprises a thickness to block wall texture from reaching the writing, wherein the foam comprises a foam material that prevents bubbles,
wherein all layers of the apparatus are rollable and unrollable without damaging the flexible foam layer through bending and without damaging the adhesive layer and the writing board layer by having the adhesive layer stuck onto the adhesive layer itself or the writing board layer.

2. The apparatus of claim 1, wherein the foam comprises a flexible high density foam.

3. The apparatus of claim 1, wherein the surface comprises a wall, object, or wood.

4. The apparatus of claim 1 further comprising a release liner attached to the flexible foam layer.

5. The apparatus of claim 1, wherein the apparatus is rollable into a packaging tube.

6. A method comprising:
producing an adhesive layer configured to be attached to a surface;
producing a writing board layer configured to be written on by a marker; and
producing a flexible foam layer attached to the adhesive layer and the writing board layer, wherein the flexible foam layer is between the adhesive layer and the writing board layer,
wherein the flexible foam layer comprises a foam, wherein the foam comprises a thickness to block wall texture from reaching the writing, wherein the foam comprises a foam material that prevents bubbles,
wherein all layers of the apparatus are rollable and unrollable without damaging the flexible foam layer through bending and without damaging the adhesive layer and the writing board layer by having the adhesive layer stuck onto the adhesive layer itself or the writing board layer.

7. The method of claim 6, wherein the foam comprises a flexible high density foam.

8. The method of claim 6, wherein the surface comprises a wall, object, or wood.

9. The method of claim 6 further comprising a release liner attached to the flexible foam layer.

10. The method of claim 6 further comprising rolling all layers into a packaging tube.

11. A method comprising:
attaching an adhesive layer to a surface;
writing on a writing board layer using a marker; and
using a flexible foam layer attached to the adhesive layer and the writing board layer, wherein the flexible foam layer is between the adhesive layer and the writing board layer,
wherein the flexible foam layer comprises a foam, wherein the foam comprises a thickness to block wall texture from reaching the writing, wherein the foam comprises a foam material that prevents bubbles,
wherein all layers of the apparatus are rollable and unrollable without damaging the flexible foam layer through bending and without damaging the adhesive layer and the writing board layer by having the adhesive layer stuck onto the adhesive layer itself or the writing board layer.

12. The method of claim 11, wherein the foam comprises a flexible high density foam.

13. The method of claim 11, wherein the surface comprises a wall, object, or wood.

14. The method of claim 11 further comprising a release liner attached to the flexible foam layer.

15. The method of claim 11 further comprising rolling all layers into a packaging tube.
